(19) United States
(12) Patent Application Publication
(10) Pub. No.: US 2020/0088934 A1
(43) Pub. Date: Mar. 19, 2020

(54) LED LIGHT SOURCE AND EDGE TYPE BACKLIGHT MODULE AND LIQUID CRYSTAL DISPLAY MODULE COMPRISING THE SAME

(71) Applicant: Huizhou China Star Optoelectronics Technology Co., Ltd., Huizhou Guangdon (CN)

(72) Inventor: Linlin FU, Huizhou Guangdong (CN)

(21) Appl. No.: 15/749,496

(22) PCT Filed: Jan. 19, 2018
(86) PCT No.: PCT/CN2018/073478

§ 371 Date: Jan. 31, 2018

(30) Foreign Application Priority Data
Dec. 28, 2017 (CN) 201711455289.6

(51) Int. Cl. F21V 8/00

(52) U.S. Cl. CPC G02B 6/0091; G02B 6/0073

(57) ABSTRACT

A LED light source includes a printed circuit board and a LED illuminator. The printed circuit board is provided with a blocking wall thereon, the blocking wall includes a blocking-wall main portion and a blocking-wall extending portion connected to each other. The blocking-wall main portion surrounds the perimeter of the LED illuminator. The blocking-wall extending portion is extended from a side of the LED illuminator and protruded from the upper surface of the LED illuminator. An edge type backlight module includes a backplane, and a light guide and the LED light source arranged on the backplane. The LED light source is arranged on the side surface of the light guide. The blocking-wall extending portion is arranged at a side of the LED illuminator far away from the backplane. Furthermore, a liquid crystal display device including the edge type backlight module is provided.

### RELATED APPLICATIONS

The present application is a National Phase of International Application Number PCT/CN2018/073478, filed Jan. 19, 2018, and claims the priority of China Application 201711455289.6, filed Dec. 28, 2017.

### FIELD OF THE DISCLOSURE

The disclosure relates to a liquid crystal display technical field, and more particularly to a LED light source, and an edge type backlight module and a liquid crystal display device comprising the same.

### BACKGROUND

A liquid crystal display (LCD) is very thin and planar display equipment. The LCD consists of the number of color pixels or the number of black or white pixels in front of a light source or a reflective surface. The LCD features very low power consumption, high resolution, small volume, and light weight. Thus, the LCD is so beloved by people and becomes a main stream of a display. The market mainly sells backlight type liquid crystal displays. The backlight type liquid crystal display includes a liquid crystal display panel and a backlight module opposite to the liquid crystal display panel. The backlight module provides a light source for the liquid crystal display panel, such that the liquid crystal display panel displays an image.

The liquid crystal display panel mainly consists of a TFT array substrate, a color filter substrate, and a liquid crystal layer. The color filter substrate includes red resisters, green resisters, and blue resisters and filters white light that passes through the liquid crystal layer to form light beams with different colors. The light beams with different colors focus to form an image. The backlight module provides a white light source for the liquid crystal panel. The backlight source of the conventional liquid crystal display equipment cold cathode fluorescent lamps (CCFLs). However, the CCFL has disadvantages of worse color recovering abilities, low lighting efficiency, a high discharging voltage, bad discharging properties at a low temperature, and a long time of reaching stable brilliance by heating. Presently, the LED backlight sources have been already developed, such as the most popular edge type LED backlight source arranged on the side surface of a light guide plate.

The LED backlight source has a Lambertian LED. The light emitted at a large angle does not enter into the light guide plate, but is directly tilted and emitted upwardly to the upper film, so as to cause a light leak. The image shows bright lines at the light-entering edge, which represents the bad display quality of the display device.

### SUMMARY

A technical problem to be solved by the disclosure is to provide a LED light source applied to an edge type backlight module to effectively solve the problem that light is emitted at a large angle to cause a light leak and improve the display quality of products.

An objective of the disclosure is achieved by following embodiments. In particular, a LED light source, and an edge type backlight module and a liquid crystal display device comprising the same.

A LED light source comprises a printed circuit board and a LED illustrator, the printed circuit board is provided with a blocking wall thereon, the blocking wall comprises a blocking-wall main portion and a blocking-wall extending portion connected to each other, the blocking-wall main portion surrounds side of a perimeter of the LED illustrator, and the blocking-wall extending portion extends from a side of the LED illustrator and protrudes from an upper surface of the LED illustrator.

In an embodiment of the present invention, the LED illustrator comprises a LED chip electrically connected to the printed circuit board and a fluorescent layer covering the LED chip.

In an embodiment of the present invention, the blocking-wall main portion has a shape of a square ring or a circle ring, and the blocking-wall extending portion has a shape of a plane panel.

In an embodiment of the present invention, the blocking wall is made of an elastic material.

An edge type backlight module comprises a backplane, and a light guide plate and a LED light source arranged on the backplane, the LED light source is arranged on a side surface of the light guide plate, the LED light source comprises a printed circuit board and a LED illustrator, the printed circuit board is provided with a blocking wall thereon, the blocking wall comprises a blocking-wall main portion and a blocking-wall extending portion connected to each other, the blocking-wall main portion surrounds side of a perimeter of the LED illustrator, the blocking-wall extending portion extends from a side of the LED illustrator and protrudes from an upper surface of the LED illustrator, and the blocking-wall extending portion is arranged at a side of the LED illustrator far away from the backplane.

In an embodiment of the present invention, the blocking-wall extending portion is extended and protruded from the upper surface of the LED illustrator to touch and connect the light guide plate.

In an embodiment of the present invention, the backplane is connected with extruded aluminum, and the LED light source is connected with the extruded aluminum.

In an embodiment of the present invention, the edge type backlight module further comprises a reflective plate and an optical film set, and the reflective plate is arranged on the backplane, and the light guide plate is arranged on the reflective plate, and the optical film set is arranged on the light guide plate.

A liquid crystal display device comprises a liquid crystal display panel and the abovementioned edge type backlight module opposite to the liquid crystal display panel, and the edge type backlight module provides a display light source for the liquid crystal display panel, such that the liquid crystal display panel displays an image.

A side of the LED illustrator of the LED light source is provided with a blocking-wall extending portion that is applied to the edge type backlight module to effectively avoid a light leak when the backlight module emits light at a large angle, thereby improving the display quality of products. Besides, since the blocking-wall extending portion is arranged near the LED illustrator, the blocking-wall extending portion with a smaller size can avoid a light leak when light is emitted at a large angle, so as to favor narrow-border display products or borderless display products.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a cross-sectional schematic view of a LED light source according to an embodiment of the disclosure;

FIG. 2 is a structural schematic view of a LED light source according to an embodiment of the disclosure;

FIG. 3 is a structural schematic view of a LED light source according to another embodiment of the disclosure;

FIG. 4 is a structural schematic view of an edge type backlight module according to an embodiment of the disclosure; and

FIG. 5 is a structural schematic view of a liquid crystal display device according to an embodiment of the disclosure.

### DETAILED DESCRIPTION OF PREFERRED EMBODIMENTS

In order to understand the above objectives, features and advantages of the present disclosure more clearly, the present disclosure is described in detail below with references to the accompanying drawings and specific embodiments. The present disclosure is only to exemplify the present invention but not to limit the scope of the present invention.

In order to avoid unnecessary details and complicate the present invention, the drawings merely show the structures and/or processing steps closely linked to the present invention and omit the other details remotely linked to the present invention.

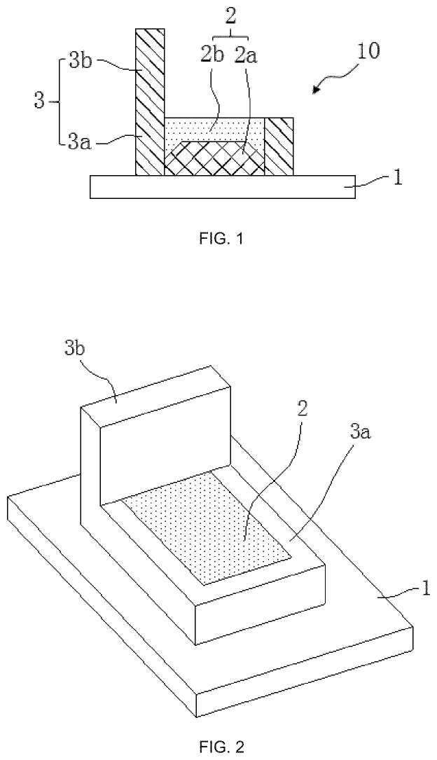

According to an embodiment of the present invention, a LED light source is provided. Refer to FIG. 1 and FIG. 2. The LED light source 10 comprises a printed circuit board (PCB) 1 and a LED illustrator 2. The printed circuit board 1 is provided with a blocking wall 3 thereon. The blocking wall 3 comprises a blocking-wall main portion 3a and a blocking-wall extending portion 3b connected to each other. The blocking-wall main portion 3a surrounds the perimeter of the LED illustrator 2, and the blocking-wall extending portion 3b is extended from a side of the LED illustrator 2 and protruded from an upper surface of the LED illustrator 2.

As shown in FIG. 1, the LED illustrator 2 includes a LED chip 2a electrically connected to the printed circuit board 1 and a fluorescent layer 2b covering the LED chip 2a. An external driving circuit transmits a driving signal to the LED chip 2a through the printed circuit board 1, such that the LED chip 2a lights up. The LED chip 2a emits a light beam to stimulate the fluorescent layer 2b, such that the LED illustrator 2 emits white light.

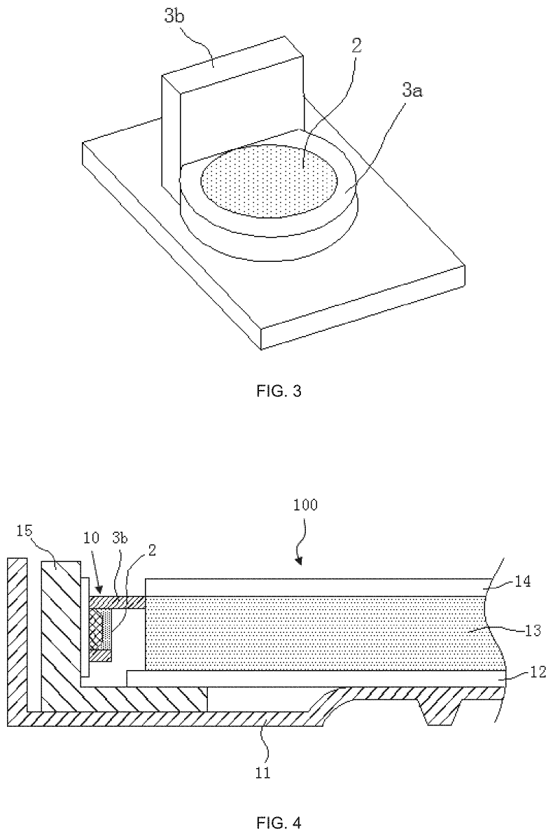

As shown in FIG. 2, the blocking-wall main portion 3a has a shape of a square ring. The LED illustrator 2 is packaged in a hollow part of the blocking-wall main portion 3a. The blocking-wall extending portion 3b is protruded from a side of the LED illustrator 2 to have a shape of a plane panel. In another embodiment, the blocking-wall main portion 3a may have a shape of a circle ring shown in FIG. 3. The LED illustrator 2 is also packaged in a hollow part of the blocking-wall main portion 3a. Correspondingly, the blocking-wall extending portion 3b is extended and protruded from a side of the LED illustrator 2 to have a shape of a plane panel.

The blocking wall 3 is preferably made of an elastic material, such as rubber.

The blocking-wall extending portion 3b is extended and protruded from a side of the LED illustrator 2 of the LED light source 10 can block (reflect) a light beam emitted by the LED illustrator 2 at a large angle.

According to an embodiment, an edge type backlight module is provided, as shown in FIG. 4. The edge type backlight module 100 comprises a backplane 11, a reflective plate 12, a light guide plate 13, and an optical film set 14, and the abovementioned LED light source 10.

Specifically, the reflective plate 12, the light guide plate 13, and the optical film set 14 are sequentially arranged on the backplane 11. The LED light source 10 is arranged on the backplane 11 and the side surface of the light guide plate 13. The light guide plate 13 guides a light beam emitted by the LED light source 10. When the light beam travels to the back surface of the light guide plate 13, the reflective plate 12 reflects the light beam to the optical film set 14, and then the light beam is emitted from the upper surface of the optical film set 14. In general, the optical film set 14 includes a prism plate and an anti-reflective coating.

In the embodiment, the backplane 11 is connected with extruded aluminum 15, and the LED light source 10 is connected with the extruded aluminum 15, as shown in FIG. 4. The extruded aluminum 15 may dissipate heat generated by the LED light source 10.

As shown in FIG. 4, the blocking-wall extending portion 3b of the LED light source 10 is arranged at a side of the LED illustrator 2 far away from the backplane 11. The blocking-wall extending portion 3b may block (reflect) a light beam emitted by the LED illustrator 0 at a large angle to effectively avoid a light leak caused by a fact that the backlight module emits a light beam at a large angle. Furthermore, since the blocking-wall extending portion is arranged near the LED illustrator, the blocking-wall extending portion 3b with a smaller size can avoid a light leak when light is emitted at a large angle, so as to favor narrow-border display products or borderless display products.

Moreover, as shown in FIG. 4, the blocking-wall extending portion 3b is extended and protruded from the upper surface of the LED illustrator 2 to touch and connect the light guide plate 13. Thus, the blocking-wall extending portion 3b can support the light guide plate 13 and position the light guide plate 13 in a traverse direction.

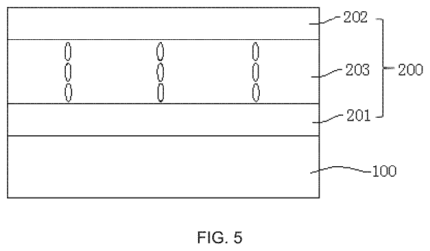

According to an embodiment, a liquid crystal display device is provided, as shown in FIG. 5. The liquid crystal display device comprises the abovementioned edge type backlight module 100 and a liquid crystal display panel 200 opposite to the edge type backlight module 100. The edge type backlight module 100 provides a display light source for the liquid crystal display panel 200, such that the liquid crystal display panel 200 displays an image. The liquid crystal display panel 200 comprises an array substrate 201 and a light-filtering substrate 202 that are opposite to each other, and a liquid crystal layer 203 between the array substrate 201 and the light-filtering substrate 202.

In conclusion, the present invention provides the LED light source and the edge type backlight module corresponded thereof. A side of the LED illustrator of the LED light source is provided with a blocking-wall extending portion that is applied to the edge type backlight module to effectively avoid a light leak when the backlight module emits light at a large angle, thereby improving the display quality of products. Besides, since the blocking-wall extending portion is arranged near the LED illustrator, the blocking-wall extending portion with a smaller size can avoid a light leak when light is emitted at a large angle, so as to favor narrow-border or borderless designs of final display products (liquid crystal display devices).

It is noted that the terms “first” and “second” are used to differ an entity or an operation from another entity or another operation. It is not necessary to represent or imply practical relationships between the entities or operations or the order of the entities or operations. Moreover, the terms “comprise” and/or “include” define the existence of described features, steps, operations, units and/or components, but do not exclude the existence or addition of one or more other features, steps, operations, units, components and/or combinations thereof.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. A LED light source, comprising a printed circuit board and a LED illuminator, wherein the printed circuit board is provided with a blocking wall thereon, the blocking wall comprises a blocking-wall main portion and a blocking-wall extending portion connected to each other, the blocking-wall main portion surrounds side of a perimeter of the LED illuminator, and the blocking-wall extending portion extends from a side of the LED illuminator and protrudes from an upper surface of the LED illuminator.

2. The LED light source according to claim 1, wherein the LED illuminator comprises a LED chip electrically connected to the printed circuit board and a fluorescent layer covering the LED chip.

3. The LED light source according to claim 1, wherein the blocking-wall main portion has a shape of a square ring, and the blocking-wall extending portion has a shape of a plane panel.

4. The LED light source according to claim 1, wherein the blocking-wall main portion has a shape of a circle ring, and the blocking-wall extending portion has a shape of a plane panel.

5. The LED light source according to claim 1, wherein the blocking wall is made of an elastic material.

6. An edge type backlight module, comprising a backplane, and a light guide plate and a LED light source arranged on the backplane, wherein the LED light source is arranged on a side surface of the light guide plate, the LED light source comprises a printed circuit board and a LED illuminator, the printed circuit board is provided with a blocking wall thereon, the blocking wall comprises a blocking-wall main portion and a blocking-wall extending portion connected to each other, the blocking-wall main portion surrounds side of a perimeter of the LED illuminator, the blocking-wall extending portion extends from a side of the LED illuminator and protrudes from an upper surface of the LED illuminator, and the blocking-wall extending portion is arranged at a side of the LED illuminator far away from the backplane.

7. The edge type backlight module according to claim 6, wherein the LED illuminator comprises a LED chip electrically connected to the printed circuit board and a fluorescent layer covering the LED chip.

8. The edge type backlight module according to claim 6, wherein the blocking-wall main portion has a shape of a square ring, and the blocking-wall extending portion has a shape of a plane panel.

9. The edge type backlight module according to claim 6, wherein the blocking-wall main portion has a shape of a circle ring, and the blocking-wall extending portion has a shape of a plane panel.

10. The edge type backlight module according to claim 6, wherein the blocking wall is made of an elastic material.

11. The edge type backlight module according to claim 6, wherein the blocking-wall extending portion is extended and protruded from the upper surface of the LED illuminator to touch and connect the light guide plate.

12. The edge type backlight module according to claim 6, wherein the backplane is connected with extruded aluminum, and the LED light source is connected with the extruded aluminum.

13. The edge type backlight module according to claim 12, further comprising a reflective plate and an optical film set, and the reflective plate is arranged on the backplane, the light guide plate is arranged on the reflective plate, and the optical film set is arranged on the light guide plate.

14. A liquid crystal display device, comprising a liquid crystal display panel and an edge type backlight module opposite to the liquid crystal display panel, the edge type backlight module provides a display light source for the liquid crystal display panel, such that the liquid crystal display panel displays an image, the edge type backlight module comprises a backplane, and a light guide plate and a LED light source arranged on the backplane, the LED light source is arranged on a side surface of the light guide plate, the LED light source comprises a printed circuit board and a LED illuminator, the printed circuit board is provided with a blocking wall thereon, the blocking wall comprises a blocking-wall main portion and a blocking-wall extending portion connected to each other, the blocking-wall main portion surrounds side of a perimeter of the LED illuminator, the blocking-wall extending portion extends from a side of the LED illuminator and protrudes from an upper surface of the LED illuminator, and the blocking-wall extending portion is arranged at a side of the LED illuminator far away from the backplane.

15. The liquid crystal display device according to claim 14, wherein the LED illuminator comprises a LED chip electrically connected to the printed circuit board and a fluorescent layer covering the LED chip.

16. The liquid crystal display device according to claim 14, wherein the blocking-wall main portion has a shape of a square ring or a circle ring, and the blocking-wall extending portion has a shape of a plane panel.

17. The liquid crystal display device according to claim 14, wherein the blocking wall is made of an elastic material.

18. The liquid crystal display device according to claim 14, wherein the blocking-wall extending portion is extended and protruded from the upper surface of the LED illuminator to touch and connect the light guide plate.

19. The liquid crystal display device according to claim 14, wherein the backplane is connected with extruded aluminum, and the LED light source is connected with the extruded aluminum.

20. The liquid crystal display device according to claim 19, further comprising a reflective plate and an optical film set, and the reflective plate is arranged on the backplane, and the light guide plate is arranged on the reflective plate, and the optical film set is arranged on the light guide plate.
